(19) United States
(12) Patent Application Publication
(10) Pub. No.: US 2011/0283709 A1
(43) Pub. Date: Nov. 24, 2011

(54) FLUIDIZED BED COMBUSTION

(75) Inventor: Tor Christensen, Sandefjord (NO)

(73) Assignee: Sargas AS, Oslo (NO)

(21) Appl. No.: 13/143,817

(22) PCT Filed: Jan. 15, 2010
(86) PCT No.: PCT/EP2010/050469

§ 371 Date: Jul. 8, 2011

(30) Foreign Application Priority Data
Jan. 15, 2009 (NO) 20090226

(51) Int. Cl. F02C 3/10

(52) U.S. Cl. 60/772; 60/734

(57) ABSTRACT

A method and a power plant for combustion of carbonaceous fuel for production of electrical power are described. The plant is a pressurized fluidized bed combustion plant wherein the compressor(s) (5, 5 . . . ) for compression of the air for the combustion is (are) arranged on shafts being separate from the shafts for the expander(s) (29) for expanding the combustion gas.

### THE FIELD OF THE INVENTION

The present invention relates to the field of Pressurized Fluidized Bed Combustion (PFBC) power plants using carbonaceous fuels, and especially a type of PFBC-plant in which also CO₂ is removed from the combustion gases. More specifically, the invention relates to improvements relating Operation of the plant. Most specifically, the invention relates to the cooperation between compressors and expanders of PFBC plants.

### BACKGROUND

A PFBC plant according to the state of the art comprises a compressor unit for compressing air for introduction into a combustion chamber in which a carbonaceous fuel is combusted. The compressed air is flowing upwards in the combustion chamber to fluidize the fuel and to supply oxygen for the combustion. Combustion gas is withdrawn from the top of the combustion chamber, at least partly cleaned by removal of dust, and then expanded over an expander unit, often also called a turbine.

The compressor unit, usually an axial compressor, may consist of a single stage compressor, but normally the compressor unit comprises two or more stages, or connected compressors, usually serially connected compressors. Intercoolers, for cooling the compressed air, are normally arranged between serially connected compressors to reduce the gas volume and to avoid overheating of the air.

The expander unit may also comprise only one expander but does normally comprise two or more serially connected expanders.

A PFBC plant is mainly configured as a gas turbine where pressurized fluidized bed combustion chamber substitutes a normally much smaller and simpler combustion chamber of a standard gas turbine. In a relatively common setup the compressor unit comprises a low pressure compressor serially connected to a high pressure compressor, and the expander unit comprises a high pressure expander serially connected to a low pressure expander but more than two steps are often used. The compressors and expanders of a standard PFBC plant are, as for gas turbines, arranged on a common shaft onto which shaft a generator is arranged to produce electrical power, and may also be used as a motor during startup of the plant.

According to an alternative prior solution the high pressure compressor and high pressure expander are arranged at one shaft, connected to a first generator/motor, and the low pressure compressor and low pressure expander are arranged on a second shaft, connected to a second generator/motor. A PFBC plant of this type is described in WO 93/06351. U.S. Pat. No. 5,544,479 relates to a circulating pressurized fluidized bed combustor, having a compressor assembly comprising a multistep compressor with inter-cooling between the steps, connected to the same shaft as the expander.

Starting up and closing down, in addition to sudden changes in operations of a gas turbine or PFBC plant may cause problems connected with the characteristics of the compressor. FIG. 2 illustrates typical characteristics for an axial flow compressor normally used in such plants, where air flow is plotted against pressure ratio.

A compressor has to be operated with care to avoid compressor choke or surge. A compressor choke is a situation of abnormal airflow resulting from a choke of the aerofoils within the compressor. The line marked “choke line” in FIG. 2 indicates mass flow vs. pressure ratio below which the compressor will choke. Compressor surge occurs when the compressor cannot add enough energy to overcome the system resistance. This causes a rapid flow reversal (i.e. surge). As a result, high vibration, temperature increases, and rapid changes in axial thrust can occur. These occurrences can damage the rotor seals, rotor bearings, the compressor driver and cycle operation. The line marked “surge line” in FIG. 2 indicates the mass flow vs. pressure ratio above which the compressor will surge. The surge line and the choke line define the area for mass flow vs. pressure ratio with which the compressor will operate. During steady state operation of a gas turbine, choke and surge are easily avoided by the design of the gas turbine and correct adjustments of the relevant parameters. Gas turbines are today design to avoid purge or choke situations but still it may occur during sudden changes in operation, and especially during startup and stopping situations.

An important difference between a PFBC and a gas turbine is the size of the combustion chamber. A combustion chamber of a gas turbine is relatively small, i.e. less than 1 m³, whereas a pressurized fluidized bed has a volume of several m³ (3000-4000 m³). The large volumes may result in surge problems in the compressor(s) when the load decrease, i.e. in a slowing down or stopping situation as the high pressure established at full load will remain high for a long time during a load decrease.

During startup and stop and during operation of the compressor, the line marked “preferred operating line” is aimed at for mass flow vs. pressure ratio to avoid surge or choke of the compressor. The large volume of the combustion chamber, in addition to a pressure chamber surrounding the combustion chamber, result in a slow pressure response at the downsteam side of the compressor to changes in the mass flow, making it difficult to avoid surge or choke conditions.

The compressor can be either in one part or in two parts, in case of two parts it contains one low pressure compressor and a high pressure compressor. The low pressure compressor is attached to the same shaft as a low pressure expander and the high pressure compressor attached to the same shaft as a high pressure expander. The disadvantage in using a gas turbine of above mentioned types is that the expanders and the connected compressors always have to have the same speed: The low pressure compressor always has to have the same speed as the low pressure expander and the high pressure compressor always has to have the same speed as the high pressure expander. The expander connected with the generator will always operate constant speed. This often causes problems with surge or choke of the compressors.

In a combustion chamber for PFBC, a number of tubes for heating feedwater to generate steam and superheated steam, are arranged in the fluidized bed area, and optionally in the area above the fluidized bed, often called the “freeboard” area. The generated steam and superheated steam, are fed to a steam turbine for generation of electricity.

In a PFBC plant, the combustion in the fluidized bed takes place at a pressure of 5-20 bar(abs). Particle cleaning components—normally cyclones—are often placed in the upper part of the main pressure vessel. Other means for removal or reduction of dust in the exhaust gas are also available.

WO 2006107209, to Sargas A S, relates to a PFBC plant of the kind described above, where CO₂ is captured from the exhaust gas before the exhaust gas is expanded over the expander. The compressor for compressing air for combustion and the expander for expanding the exhaust gas are arranged on a common shaft.

CO₂ capture reduces the volume of the exhaust gas substantially, i.e. dependent on the concentration of CO₂ in the exhaust gas, with up to about 15%, a reduction that may cause imbalance between the compressor and expander if not taken into account in the engineering of the combination. Additionally, the temperature of the combustion gases has to be decreased in a heat exchanger outside the pressure vessel, down to about 120° C., before introduction of the exhaust gas into the CO₂ capture device. Even though the exhaust gas leaving the CO₂ capture unit is reheated by heat exchanging against the hot exhaust gas from the combustion chamber before being expanded over the expander, some heat is lost. Both the loss of CO₂ and loss of heat causes reduction in output from the expander that has to be accounted for.

Additionally, the mass flow into the compressor may vary with the density of the ambient air due to the ambient temperature, humidity and atmospheric pressure. U.S. Pat. No. 6,305,158 relates to a combustion turbine power plant where additional compressed air is introduced into the combustion chamber to increase the power production from the turbine plant. The additional air is introduced form a separate compressor unit operated by a motor. According to one embodiment, the separate compressor unit may be connected to an underground compressed air storage into which compressed air may be introduced in low energy price periods, to work as air supply in periods with higher energy cost.

WO2005027302 relates to a different embodiment of a energy storage system where energy is stored as compressed air during periods of low cost for electrical energy, and where the compressed air is expanded over expanders in periods with higher need and cost for electrical power. The compressed air may optionally be heated by heat exchanging in a combustion chamber, for example a combustion chamber of a gas turbine.

The problem described above with relation to avoiding choke and surge situations for compressors in a PFBC plant is solved by the mentioned publications.

### SUMMARY OF THE INVENTION

According to a first aspect of the present invention, the problem is solved by means of a power plant for combustion of carbonaceous fuel for production of electrical power, comprising a compressor unit, comprising one or more compressors, for compression of air, a combustion chamber, and fuel line(s) for injecting fuel into the combustion chamber, where an air line is provided for introducing the compressed air from the compressor unit into the combustion chamber to provide a pressurized fluidized bed for combustion of fuel and air, where a combustion gas line is provided to lead the combustion gas from the combustion chamber to an expander unit, comprising one or more expanders, for expanding the exhaust gas before being released to the surroundings, the expander unit being connected to one or more generator(s) for generation of electrical power, wherein the compressor(s) for compression of the air are arranged on shafts being separate from the shafts for the expander(s) for expanding the combustion gas.

By arranging the compressor unit and the expander unit on different shafts, the compressor unit and the expander unit may be operated separately from each other, making it possible to obtain optimal conditions for the compressor during start and stop situations as well as during sudden changes in the operation of the plant.

By separating these main components it will be possible to operate the compressor(s) at different speeds. Especially, it will be possible to operate the compressor at high speed when there is a risk for surge in the compressor. Separation of the compressor and expander on different shafts also makes it possible to regulate the input of compressed air to compensate for variations in air density. By having the compressor and expander on different shafts, the load and thus the rotational speed of the compressor may be adjusted without effecting at the same time as the expander is allowed to operate at de demanded load depending on the need for power. For power plants situated at high levels, the atmosphere will have a low density which will give a lower air flow from the compressor. In such cases it is possible to install a compressor with higher capacity so that the full load of the plant can be reached. For power plant situated in warmer areas, the air flow from the compressor will also be low. With a separate compressor this can be compensated for by selecting a larger compressor

The surge line is considerably higher in a compressor characteristic at high compressor speeds than at low compressor speeds as illustrated in FIG. 2.

In existing plants if using a twin shafted machine, this is done by decreasing the bed height and thereby also steam production in the fluidized bed lowering the electricity production from the steam turbine and by that getting lower temperature to the gas expander in which also the produced power will decrease. To do this also the air flow need to be reduced, and that is done by changing the temperature to the turbine (and thereby its power) which also will change the speed of the LP-expander and thereby also the speed of the LP compressor. This can be performed within limitations by having an adjustable guide vane at the inlet of the LP gas expander. This will result in that the speed of the compressor will decrease.

In case of a one shafted machine, running at constant speed as it is connected to the generator, the change in air flow need to be carried out by a number of adjustable guide vanes in the compressor with individual controls.

Such guide vanes have a limited operating range. In a plant according to the invention the fuel flow to the bed can be cut off rapidly and the compressor speed, and thereby air flow, can easily be adjusted to a desired according to the process in order to avoid surge. This relates not only to normal load changes, but especially to normal shut downs as well as unexpected load changes and shut downs as it is possible to cool down the plant much faster and, important, the plant can be shut down in a much faster and safer way.

According to one embodiment, one or more unit(s) for treatment of the exhaust gas is (are) arranged between the combustion chamber and the expander. Exhaust gas from a pressurized fluidized bed combustion chamber normally comprises large amounts of dust that has to be removed or at least substantially reduced to avoid contamination and/or erosion of downstream equipment. The unit(s) may also comprise other pollution reducing devices, such as a SCR unit, and one or more heat exchanger(s).

According to one embodiment, a CO₂ capturing unit is arranged between the combustion chamber and the expander. Arrangement of a CO₂ capture unit between the combustion chamber and the expander allows for high pressure absorption of CO₂ in the CO₂ capture unit, which has the advantages of high partial pressure of CO₂ to accelerate the absorption compared to atmospheric absorption. Additionally, at a high pressure, the gas volume is smaller, thus reducing the required volume of the equipment. Introduction of CO₂ capture between the combustion chamber and the expander do, however, reduce the total gas flow through the expander as the CO₂ is removed from the gas before expansion. Additionally, the temperature and gas flow to the expander after CO₂ removal may be too low for the expander to power the compressor, thus making it impossible to use a standard one shaft compressor and turbine unit. This problem is solved by the present invention with compressor and expander on separate shafts.

According to a second aspect, the present invention relates to a method for operating a pressurized fluidized bed combustion plant, where air is compressed in a compression unit, the compressed air is introduced into a pressurized fluidized bed combustion chamber where carbonaceous fuel is combusted in presence of the air, where the temperature in the combustion chamber is kept between 750° and 1000° C. by generation of steam and superheated steam in heat coils in the combustion chamber, and where the combustion gas from the combustion chamber is expanded over an expander connected to a generator to generate electrical power, wherein the compressor is operated by a motor being separate from the expander.

### SHORT DESCRIPTION OF THE FIGURES

FIG. 1 shows a process overview over a Pressurized Fluidized Bed Combustion plant (PFBC-plant) equipped with equipment for removal of CO₂ from the combustion gases.

FIG. 2 shows a typical characteristic for an axial flow compressor for compressing air. Pressure ratio is the ratio between the outlet pressure and the inlet pressure.

FIG. 3 a) to d) show different methods to connect several compressors (constituting the compressor unit) if more than one compressor is used.

### DETAILED DESCRIPTION OF THE INVENTION

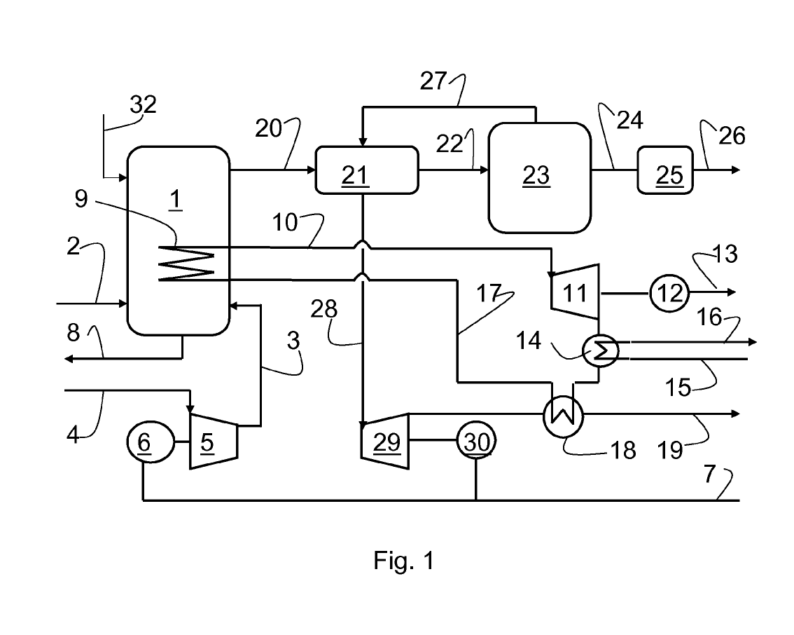

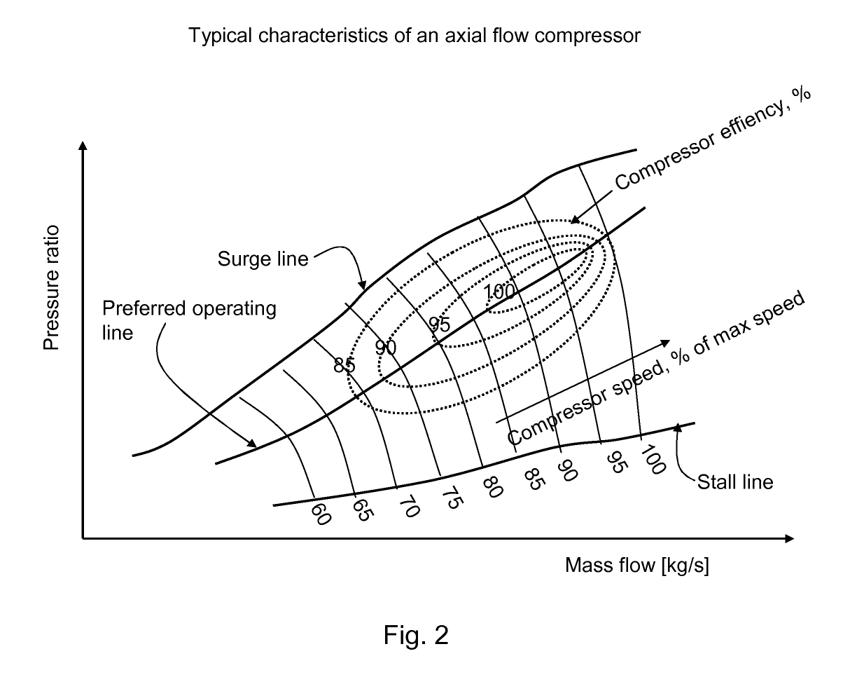

FIG. 1 is a process flow diagram for a PFBC plant according to the present invention. Pressurized combustible fuels are introduced into a combustion chamber 1 through a fuel line 2. Pressurized air is introduced into the combustion chamber 1 through a compressed air line 3, and is caused to flow upwards in the combustion chamber to fluidize the fuel therein to give a fluidized bed, and to provide oxygen for the combustion of the fuel.

Air is introduced through an air line 4 into a compressor unit 5 where the air is compressed to a pressure in the range 5-20 bar(abs). The compressor 5 is driven by an electrical motor 6 receiving electricity through an electrical line 7. From the compressor unit 5, the compressed air is led to the combustion chamber through the line 3.

The combustion chamber 1 is normally enclosed by a not shown pressure chamber into which the compressed air is introduced. The compressed air is then introduced into the combustion chamber through air inlets. The pressure in the pressure chamber is substantially the same as the pressure in the combustion chamber, and the pressure of the compressed air in line 3, i.e. 5-20 bar(abs).

The most used fuel for PFBC has so far been coal but also other combustible fuels such as for example gas, oil, oil shale, coal, wood chips, peat or any bio-, fossil- or synthetic fuel or a mixture of these fuels, may be used.

Solid fuel is crushed or pulverized to give fuel particles before introduction into the combustion chamber. The crushed or pulverized fuel may be introduced in dry state into the combustion chamber, or be mixed with a liquid to give a paste that is pumped into the combustion chamber.

Depending on the fuel quality, especially with respect to sulfur content, a sulfur absorbent, such as crushed or pulverized limestone or dolomite, may be introduced into the combustion chamber, either separately or mixed with the crushed or pulverized fuel.

Liquid fuels may be mixed with solid fuel components or absorbent before introduction into the combustion chamber, or may be introduced as such through liquid injection nozzles, whereas gaseous fuel is introduced into the combustion chamber via gas injection nozzles.

Ash and used absorbent may be withdrawn from the combustion chamber through an ash line 8 in a well known manner.

Ammonia may optionally be introduced into the freeboard area, or area above the fluidized bed, for removal of substantial reduction of NOx in the combustion gas. Introduction of ammonia in the freeboard are, may however, dependent on the materials used for the combustion chamber and downstream thereof, cause erosion.

The temperature in the fluidized bed held at 750 to 1000° C. by cooling of the combustion gases by generation of steam and superheated steam in cooling tubes 9 arranged in and above the fluidized bed. Preferably the temperature is held between 800 and 900°, such as e.g. at about 850° C.

The steam and superheated steam generated in the tubes 9 is withdrawn through steam line 10 and is expanded over a steam expander 11 being connected to a generator 12 for generation of electrical power that is exported from the plant through a line 13.

The expanded steam leaving the steam expander 11 is cooled in a heat exchanger 14 against a heat medium that is introduced through a line 15 and withdrawn through a line 16. The cooled and condenced steam leaves the heat exchanger 14 through a retour line 17 and is returned to the tubes 9 for generation of steam and superheated steam as described above. The content in line 17 is optionally heated in a heat exchanger 18 against exhaust gas leaving the plant in an exhaust gas line 19, before re-entering the tubes 9. A feedwater pump (not shown) is used to increase the pressure of the water downstream of the condenser in order to get a circulation.

Combustion gases are withdrawn from the top of the combustion chamber through combustion gas line 20. Coarse particles of ash and used absorbent are, as mentioned above, withdrawn from the bottom of the combustion chamber. The combustion gas leaving through line 20 does, however, include substantial amounts of dust, and NOx if no ammonia has been intruded into the freeboard area through line 32.

A gas treatment unit 21 is arranged to remove all or most of the dust, and cool the combustion gas before further treatment. Additionally, if NOx is not removed by introduction of ammonia in the freeboard, the gas treatment preferably includes a Selective Catalytic Reduction unit for removal of NOx.

Conventional means for removing dust are cyclones, filters and the like, alone or in combination with each other. The methods and means for cleaning the combustion gas is not a part of the present invention, and are therefore not described in any more details. The skilled man in the art will understand how to obtain a combustion gas that is substantially free of dust and NOx by means of well known methods and means. The gas treatment unit 21 also includes one or more heat exchangers for cooling the combustion gas before the gas is withdrawn from the gas treatment unit 21 through a line 22. The combustion gas is preferably cooled to below 130° C., such as below 120° C. or below 110° C., such as about 100° C., before leaving the gas treatment unit 21.)

The cleaned and cooled combustion gas is withdrawn from the treatment unit 21 through a gas line 22 to be introduced into a CO₂ capture unit 23. In the CO₂ capture unit 23, CO₂ is captured from the combustion gas in an absorption/desorption cycle. In the absorption/desorption cycle, a liquid absorbent, such as an aqueous solution of carbonate or amine, is circulated through an absorber, in which the combustion gas is caused to flow countercurrent to the CO₂ absorbent to give a CO₂ depleted combustion gas that is withdrawn from the capture unit 23 through a line 27, and a CO₂ rich absorbent that is withdrawn from the absorber and introduced into a desorber, or regenerator, where the absorbed CO₂ is released from the absorbent to give a stream of CO₂ and steam that is withdrawn from the CO₂ capture plant through a CO₂ line 24, and regenerated absorbent, that is re-introduced into the absorber.

CO₂ and steam in line 24 is further treated in a CO₂ treatment unit, wherein the CO₂ is dried to remove water, and compressed to produce compressed CO₂ that is exported from the plant.

The CO₂ depleted combustion gas in line 27 is reheated by heat exchanging in the gas treatment unit 21 against the combustion gas from the combustion chamber. The CO₂ depleted and reheated combustion gas is then withdrawn from the gas treatment unit 21 through a line 28 and is expanded over an expander 29 connected to a generator 30 to produce electrical power. That is delivered to the electrical line 7. Before expansion over the expander 29, the pressure of the gas in line 28 is slightly lower than pressure in the combustion chamber 1. The combustion gas is not expanded after leaving the combustion chamber, before being introduced into the expander 28. Accordingly, the pressure difference between the gas in line 28 and the combustion chamber 1 is due to the pressure drop through the plant. The mass flow in line 28 is, however, reduced compared with the mass flow through line 20 due to removal of CO₂ from the flow. The electrical energy produced in the generator 30 is therefore lower that would have been the case if the CO₂ capture was omitted.

The compressor unit 5 and the expander unit 29 are arranged on different shafts to allow independent operation of the compressor unit and the expander unit.

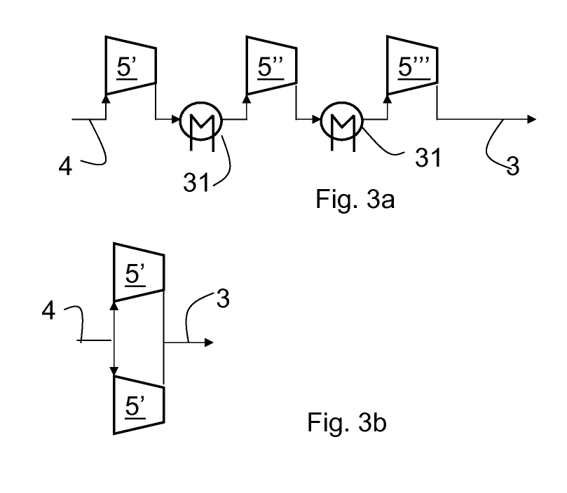

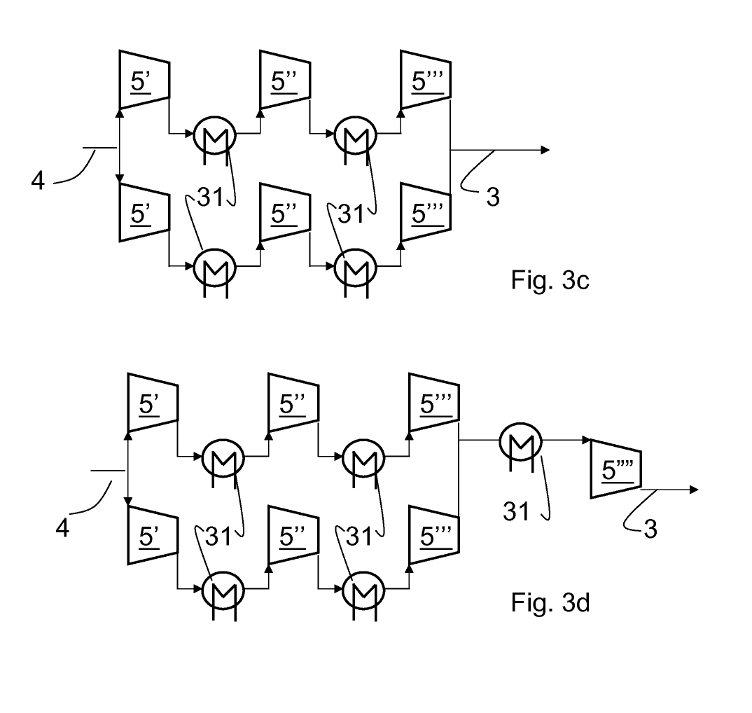

The compressor unit 5 may comprise one or preferably, more than one compressors, 5′, 5″, 5′″, 5″″ etc., depending on the actual configuration and size of the plant. FIGS. 3a, 3b, 3c and 3d, illustrates some examples on compressor configurations. Intercoolers 31 are preferably arranged between the steps of serially connected compressors to reduce the energy demand for the compression of the air.

Serially connected compressors may be arranged on a common shaft operated by a common motor, or may be operated by separate motors. Normally, the compressors are arranged on a common shaft operated by one motor 6, to save cost.

The expander unit 29 may consist of one expander, or of two or more serially connected expanders, preferably arranged on a common shaft that is also connected to a generator 30.

The motor 6 for operation of the compressor(s), and generator 30 for generating electrical power from the expanders, are electrically connected as the generator 6 delivers electrical power to the same electrical line (or grid) as the power for operation of the motors receives electricity from. Depending on the mode of operation, the specific design of the plant etc, the sum of the electrical consumption by motor(s) 6 and production from generator 30, may be positive or negative, and is balanced by input or output of electrical power to a local or common grid.

By having the compressor(s) 5 for compression of air for the combustion chamber, and expander(s) 6 for expanding the combustion gas before the combustion gas is released into the atmosphere, on different shafts, the compressor(s) and expander(s) may be operated independent from each other to adjust for specific needs.

1. A power plant for combustion of carbonaceous fuel for production of electrical power, comprising:
a compressor unit comprising one or more compressors for compression of air;
a combustion chamber;
fuel line(s) for injecting fuel into the combustion chamber;
wherein an air line is provided for introducing compressed air from the compressor unit into the combustion chamber to provide a pressurized fluidized bed for combustion of fuel and air;
wherein a combustion gas line is provided to lead combustion gas from the combustion chamber to an expander unit, the expander unit comprising one or more expanders for expanding exhaust gas before being released to the surroundings;
wherein the expander unit is connected to one or more generator(s) for generation of electrical power; and
wherein the compressor(s) for compression of the air are arranged on shafts that are separate from the shafts for the expander(s) for expanding the combustion gas.

2. The power plant of claim 1, wherein one or more unit(s) for treatment of the exhaust gas is (are) arranged between the combustion chamber and the expander unit.

3. The power plant of claim 2, wherein a CO2 capturing unit is arranged between the combustion chamber and the expander unit.

4. The power plant of claim 3, wherein a gas treatment unit for removal of dust and, optionally, NOx from the combustion gas is provided between the combustion chamber and the CO2 capturing unit.

5. The power plant of claim 4, wherein the gas treatment unit comprises one or more heat exchangers to cool the exhaust gas from the combustion chamber against low CO2 exhaust gas leaving the CO2 capturing unit before the low CO2 exhaust gas is expanded over the expander unit.

6. The power plant of claim 1, wherein the compression unit comprises two or more serially connected compressors and where one or more intercooler(s) is (are) arranged between the serially connected compressors.

7. The power plant of claim 6, wherein the serially connected compressor(s) of the compression unit are arranged on a common shaft.

8. The power plant of claim 1, wherein two or more of the compressors are arranged in parallel.

9. A method for operating a pressurized fluidized bed combustion plant, where air is compressed in a compression unit, the compressed air is introduced into a pressurized fluidized bed combustion chamber where carbonaceous fuel is combusted in presence of the air, where the temperature in the combustion chamber is kept between 750° and 1000° C. by generation of steam and superheated steam in heat coils in the combustion chamber, and where the combustion gas from the combustion chamber is expanded over an expander connected to a generator to generate electrical power, wherein the compressor is operated by a motor being separate from the expander.
